(19) United States
(12) Patent Application Publication
(10) Pub. No.: US 2002/0001378 A1
(43) Pub. Date: Jan. 3, 2002

(54) Communication apparatus

(76) Inventor: Yoshikatsu Ooi, Osaka (JP)

Correspondence Address: NIXON & VANDERHYE P.C., 8th FLOOR, 1100 NORTH GLEBE ROAD, ARLINGTON, VA, 22201-4714, US

(21) Appl. No.: 09/878,188

(22) Filed: Jun. 12, 2001

(30) Foreign Application Priority Data
Jun. 30, 2000 (JP) P2000-199340

(51) Int. Cl. H04M 7/00; H04M 15/00

(52) U.S. Cl. 379/221.01; 379/93.09; 379/114.02

(57) ABSTRACT

The invention provides a communication apparatus capable of practically using a line selecting function such as an LCR function, in a system in which a plurality of communication apparatuses including the communication apparatus are connected in parallel to each other on one line. Therefore, a facsimile apparatus and a telephone set are connected in parallel to each other on the same line. When the facsimile apparatus detects a dial signal sent by the telephone set, the facsimile apparatus converts the detected dial signal to another dial signal by referring to an LCR table stored to a RAM. The facsimile apparatus sends the converted dial signal to a switching apparatus over a line, and establishes a least expensive communication line among public communication lines.

### BACKGROUND OF THE INVENTION

1. Field of the Invention

The present invention relates to a communication apparatus for performing a calling operation in a system in which a plurality of communication apparatuses such as a telephone set, a facsimile apparatus, a personal computer having a communication function are connected to one line in parallel.

2. Description of the Related Art

Public communication lines are managed at present among different communication carriers. When a user communicates with others over the public communication lines using a telephone, a facsimile, data communication system, the user can select a desired one from among the public communication lines in consideration of communications cost, communications quality etc. The communication cost is generally calculated based on communication starting time, communication distance, communication time etc. Each communication carrier, however, adopts its own charge-calculation system, and therefore, in cases where communication qualities provided by the communication carriers are the same, it is of benefit to the user to select a cheapest communication line.

In making a call with a telephone set provided with an LCR (Least Cost Routing) function, in response to a user's dialing, the least expensive communication line is automatically selected from among a plurality of communication lines managed by a plurality of communication carriers and the call is made. Therefore, it is not necessary for the user to recognize the difference in communication charge calculating method every dial operation. The user is free from being annoyed by the need of calculating communication costs on a call by call basis.

In the LCR function, a suitable communication line is selected by referring to communication starting time and communication distance using an LCR table downloaded from an LCR center managed by the plurality of communication carriers, to each communication apparatus periodically or at any time, and a corresponding identification number is added to a called party's number in making a call.

In connection with related art, Japanese Unexamined Patent Publication JP-A 6-78132 (1994) discloses a facsimile apparatus in which a time necessary for communication is calculated from the amount of data to be transmitted and an LCR table is referred to, and Japanese Unexamined Patent Publication JP-A 8-130594 (1996) discloses a discount service route selecting method for updating an LCR table in consideration of a fixed amount charge service.

In the case of a system in which several communication apparatuses are connected to one line in parallel, a so-called master/slave-units telephone system, the LCR function cannot be utilized in such case where only one unit is provided with the LCR function while the other units being not provided. Therefore, when a user makes a call using one of the non-LCR units, the user has to ponder which communication line is reasonable for the call, and is required to manually add an identification number corresponding to the communication line on a call by call basis, where calling operation is bothersome.

### SUMMARY OF THE INVENTION

An object of the invention is to provide a communication apparatus capable of practically using a communication line selecting function such as an LCR function, in a system in which a plurality of communication apparatuses including the communication apparatus are connected to one line in parallel.

The invention provides a communication apparatus for communicating over a line connected to a public communication line via a switching apparatus, comprising:

call detecting means for detecting a dial signal sent by another communication apparatus connected to the line in parallel;

dial converting means for converting the dial signal detected by the call detecting means to another dial signal; and

call sending-out means for sending the other dial signal converted by the dial converting means to the switching apparatus, and establishing a communication line.

In accordance with the invention, the dial signal sent by another communication apparatus connected to the line in parallel is detected and converted to another dial signal, and the resultant converted signal is sent out to the switching apparatus. Accordingly, a desired predetermined dial signal can be sent out to the switching apparatus by simply performing a normal call operation from the other communication apparatus by a caller.

Therefore, since addition of an identification number for selecting a desired public communication line is carried out in the dial conversion, an additional operation of adding the identification number to a called party's number by the caller can be omitted and the caller's dial operation can be simplified. Even when a called party's number is changed to a new one in certain circumstances such as house-moving or a change in station number, the caller can make a call from the old number of the called subscriber by associating the old number with the new one in advance, thereby improving convenience.

Further, in the invention it is preferable that the dial converting means has a line selection table for use in selecting a desired public communication line from among a plurality of public communication lines.

In accordance with the invention, the line selection table for use in selecting a desired public communication line from among a plurality of public communication lines is provided so that an optimum line can be selected each time by referring to a table in which various kinds of conditions are set in advance, every communication start.

In the invention it is preferable that the line selection table is an least cost routing table.

In accordance with the invention, a communication interval, a basic charge, an additional charge, a midnight charge, a holiday charge and the like are set as a database for each of a plurality of public communication lines in the LCR table. Therefore, the caller can achieve communication over a least expensive public communication line by simply performing the normal call operation from the other communication apparatus.

In the invention it is preferable that the call detecting means activates the dial converting means when the call detecting means detects a predetermined signal in the dial signal sent by the other communication apparatus.

In accordance with the invention, a signal using or inhibiting a dial converting function is set in advance, and the activating of the dial converting means is controlled by detecting whether or not the predetermined signal exists in the dial signal sent by the other communication apparatus. Thus, the user can arbitrarily switch use or unuse of the dial converting function.

In the invention it is preferable that the dial detecting means detects the dial signal by a high input impedance, and

the dial sending-out means captures the line when a predetermined time has elapsed since release of the line and sends the converted dial signal.

In accordance with the invention, the dial signal can be detected in a release state of the line by detecting the dial signal by the high input impedance so that errors in operations of the other communication apparatus and the switching apparatus can be prevented.

By capturing the line and sending-out the converted dial signal when a predetermined time has elapsed since release of the line, the switching apparatus can reliably recognize that calling from the other communication apparatus is interrupted, and recognize the converted dial signal which is subsequently sent out.

In the invention it is preferable that the communication apparatus comprises line release instruction means for, when the dial detecting means detects the dial signal sent from the other communication apparatus, instructing the other apparatus to release the line.

In accordance with the invention, after the dial signal is detected, the other communication apparatus is instructed to release the line by a voice, a melody, a tone, so that the other communication apparatus can recognize timing of releasing the line. Accordingly, a calling operation to the switching apparatus can be reliably interrupted.

In the invention it is preferable that when the other communication apparatus releases the line after the sending-out of the dial signal and again captures the line, the dial sending-out means sends the converted dial signal.

In accordance with the invention, it is possible to recognize that the calling operation to the switching apparatus from the other communication apparatus is interrupted. Therefore, the calling operation using the converted dial can be reliably executed.

In the invention it is preferable that the predetermined signal is composed of one or more of dial keys #, *, 0 to 9.

In accordance with the invention, a signal pattern constructed by a combination of one or more of dial keys #, *, 0 to 9 is allocated in advance to a command signal for operation control so as to distinguish a command operation from the normal call operation. Thus, it is possible to discriminate whether it is a signal from the normal call operation or a command signal among signals sent out by the other communication apparatus.

In the invention it is preferable that, when the dial detecting means detects the predetermined signal in the dial signal sent out by the other communication apparatus, the dial detecting means judges that sending-out of the dial signal is completed.

In accordance with the invention, at an arriving time point of a call sending-out completion command composed of a combination of one or more of dial keys #, *, 0 to 9, the sending-out of the dial signal is judged as being completed. Thus, the next operation can be immediately started.

In the invention it is preferable that, when the predetermined signal is detected in the dial signal sent-out by the other communication apparatus, when the sending-out of the dial signal is interrupted for a predetermined time, when a digit number of the detected dial signal is insufficient or excessive, or when the line is released during the sending-out of the dial signal, the dial detecting means does not activate the dial converting means.

In accordance with the invention, interruption of the call operation in the other communication apparatus can be reliably recognized so that interruption processing can be immediately started.

In the invention it is preferable that when the dial sending-out means detects, in capturing the line and sending out the converted dial signal, a busy tone from the switching apparatus, the dial sending-out means releases the line for a predetermined time and thereafter captures the line to send the converted dial signal.

In accordance with the invention, when the busy tone is detected in sending out the converted dial signal, the switching apparatus can rapidly perform line release processing by once releasing the line.

In the invention it is preferable that the communication apparatus comprises call completion notifying means for notifying the other communication apparatus of call completion when the dial converting means completely sends the converted dial signal.

In accordance with the invention, the call completion is notified to the other communication apparatus by a voice, a melody, a tone, after the converted dial signal is completely sent out. Thus, the other communication apparatus can recognize timing of communication line establishment.

In the invention it is preferable that when the other communication apparatus sends a predetermined signal during the notification of the call completion by the call completion notifying means, the call completion notifying means terminates the notification of the call completion.

According to the invention, when the other communication apparatus sends a predetermined signal during the notification of the call completion by a voice, a melody, a tone or the like, the call completion notifying means terminates the notification of the call completion. Accordingly, it is possible to prevent a voice, a melody, a tone or the like from being mixed at a talking start time with a called part.

As explained above in detail, in accordance with the invention, the dial signal sent by the other communication apparatus connected in parallel to the line is detected and converted to another dial signal, and this converted dial signal is sent out to the switching apparatus. Thus, a user can send a desired predetermined dial signal to the switching apparatus by simply performing the normal call operation from the other communication apparatus. Convenience of the user is improved by automatically adding an identification number using e.g., an LCR function, in the dial conversion.

### BRIEF DESCRIPTION OF THE DRAWINGS

Other and further objects, features, and advantages of the invention will be more explicit from the following detailed description taken with reference to the drawings wherein:

FIG. 1 is a schematic view showing an example of a communication network to which a communication apparatus of the invention is applied;

FIG. 2 is a block diagram showing an embodiment of the invention;

FIGS. 3A and 3B are timing charts for explaining the operation of a proxy LCR function; and

FIGS. 4A and 4B are operation flowcharts of a on-hook and off-hook instruction system provided to the facsimile apparatus 31.

### DETAILED DESCRIPTION OF THE PREFERRED EMBODIMENTS

Now referring to the drawings, preferred embodiments of the invention are described below.

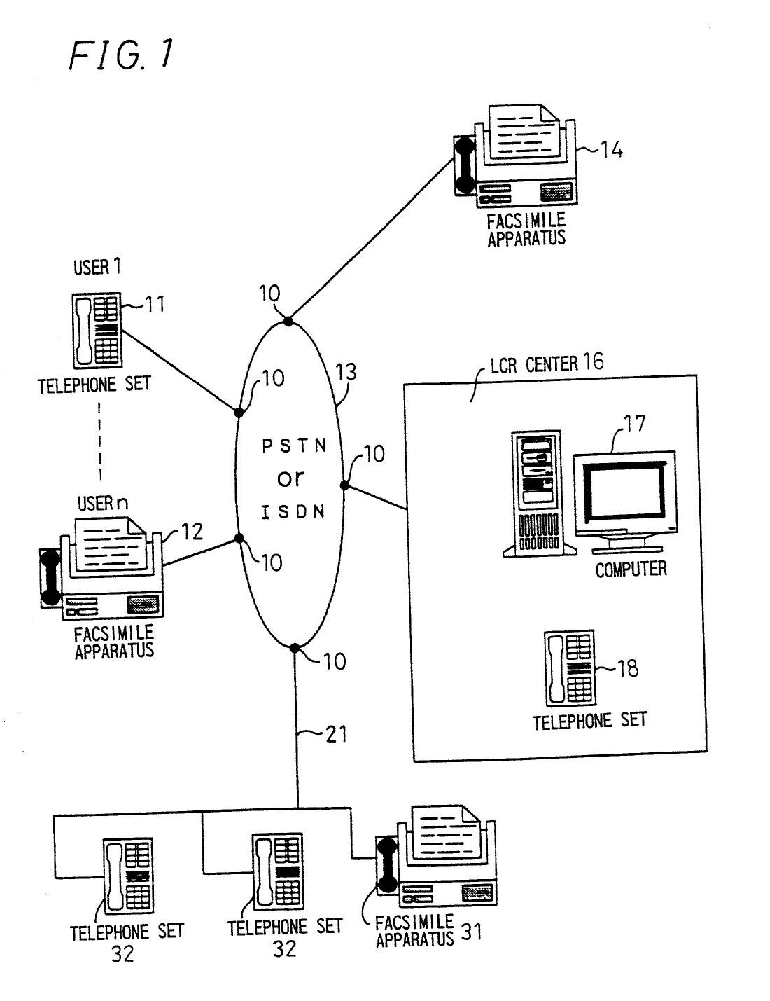

FIG. 1 is a schematic view showing an example of a communication network to which a communication apparatus of the invention is connected. Various kinds of communication apparatuses such as a telephone set 11, facsimile apparatuses 12, 14, are connected to a public communication line 13 such as PSTN (Public Switched Telephone Network) or ISDN (Integrated Services Digital Network) via a switching apparatus 10.

From the switching apparatus 10 to subscribers are branched a lot of lines, and to one of the lines are connected in parallel a facsimile apparatus 31 and a plurality of telephone sets 32, making a so-called master/slave units telephone system.

The public communication line 13 is composed of a plurality of lines managed among a plurality of communication carriers. Their charge-calculation systems and discount rates, and qualities and contents of their services are different from each other. Namely these are dependent on which communication line the switching apparatus 10 is connected to. In order for a caller to select a desired communication line on a call by call basis, it is required to input an identification number corresponding to the desired communication line in addition to a called party's telephone number, so that the switching apparatus 10 at a connection branch point can establish a communication line corresponding to the identification number.

The facsimile apparatus 31 has an LCR function for automatically adding an identification number of the least expensive line selected in accordance with various conditions such as a connection starting time, a call distance and a total time connected. The facsimile apparatus 31 stores in an internal memory, an LCR table consisting of charge-calculation databases.

In an LCR center 16 that is managed by communication carriers, a computer 17, a telephone set 18 and so on are arranged via a switching apparatus. Many charge-calculation databases optimized in accordance with information such as a caller's location are stored in the computer 17. The computer 17 transmits, periodically or on-demand basis, data required for correction of an LCR table stored in an LCR communication apparatus.

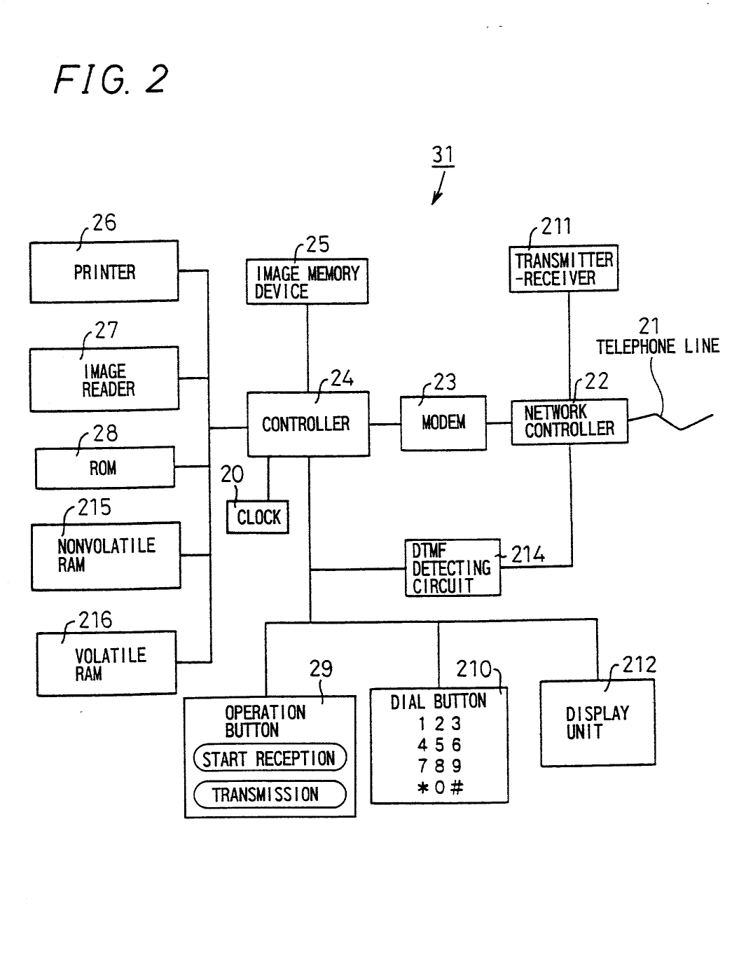

FIG. 2 is a block diagram showing one embodiment of the invention. The facsimile apparatus 31 includes a network controller 22, a handset 211, a modem 23, a controller 24, an image memory device 25, a printer 26, an image reader 27, a ROM (Read Only Memory) 28, a nonvolatile RAM (Random Access Memory) 215, a volatile RAM 216, a clock circuit 20, operation keys 29, dial keys 210, a display unit 212 and a DTMF (Dual Tone Multi Frequency) detecting circuit 214.

The network controller 22 controls the capture or release of a line 21, and establishes a communication path with a called party's communication apparatus over the captured line 21. The network controller 22 also monitors the line 21 to switch between the handset 211 and the modem 23 for an appropriate connection over the line 21.

The handset 211 has a microphone and an ear speaker for voice communication with a called party's telephone set.

The modem 23 modulates digital signals such as image data to signals conformed to communication standards of the line 21, and also demodulates signals received from the line 21 to digital signals such as image data.

The printer 26 may be of a thermal printing system, an electrophotographic system, an ink jet system and so on, and performs printing on a sheet of paper based on the image data. When used as a facsimile apparatus, the printer 26 prints image data received over the line 21. When used as a copying machine, the printer 26 prints image data read by the image reader 27.

The image reader 27 comprises a reduction reading system including a combination of a lens and a CCD (charge coupled device), a contact sensor using a rod lens array, and reads an original image to convert to image-data. When used as a facsimile apparatus, the image data read by the image reader 27 is transmitted to a called party's communication apparatus over the line 21. When used as a copying machine, the image data read by the image reader 27 is sent to the printer 26.

The image memory device 25 comprises a memory for storing image data read by the image reader 27 and image data received over the line 21. For example, when printing paper runs out on a facsimile apparatus, the image memory device 25 accumulates received data. The image memory device 25 is also used to realize a multiple address transmission, for transmitting stored image data to a plurality of target destinations at a time.

The ROM 28, the nonvolatile RAM 215 and the volatile RAM 216 are used to store data, programs and so on. The ROM 28 is a read only memory in which stored contents are maintained even after a power source is turned off. The nonvolatile RAM 215 is a rewritable memory, which is kept energized at all times by a backup battery or the like. The volatile RAM 216 is a rewritable memory in which stored contents are vanished when the power source is turned off.

The dial key 210 includes 12 push switches corresponding to dial keys #, *, 0 to 9.

The operation key 29 includes operation switches other than the dial key 210. For example, the operation key 29 can be a receiving switch for accepting facsimile reception and a transmission switch for sending facsimile transmission.

The display unit 212 comprises a liquid crystal panel, an LED (light emitting diode) or the like, and displays various kinds of information and operation guidance for a user's convenience.

The DTMF detecting circuit 214 monitors at all times whether or not a DTMF signal and any other kinds of signals are transmitted over the line 21.

The clock circuit 20 counts current date, day of the week and time even when the power source is turned off.

The controller 24 entirely controls the operation of a communication apparatus in accordance with a program stored in the ROM 28, and controls the operation of each of the units based on operation information from the dial key 210 and the operation key 29 and a command sent over the line 21.

In a facsimile receiving mode, when a facsimile signal is transmitted from another communication apparatus over the public communication line 13, the switching apparatus 10 and the line 21, the network controller 22 switches the connection to the modem 23, and the modem 23 demodulates the facsimile signal. Since demodulated data is compressed image data, the controller 24 restores the demodulated data to original image data by performing image expansion processing. When restored image data is sent to the printer 26, a transmitted image is recorded onto a printing paper.

In a facsimile transmission mode, when the image reader 27 reads an original image, the controller 24 sends the original image to the modem 23 by performing image compression processing. The modem 23 modulates the original image to a facsimile signal, and transmits the facsimile signal to a called party's communication apparatus over the line 21, the switching apparatus 10 and the public communication line 13.

In a voice communication mode, the network controller 22 switches the connection of the line 21 to the handset 211.

With the LCR function, an LCR table transmitted from the LCR center 16 is first stored in the volatile RAM 216, and then, such data in the table that should be maintained even after the power source is turned off is also stored in the nonvolatile RAM 215.

When a caller inputs a called party's telephone number using the dial key 210 on an LCR apparatus, the controller 24 analyzes the inputted number, extracts an area code therefrom, and reads the current time and day from the clock circuit 20. Referring to the LCR table, the controller 24 selects the least expensive communication line in accordance with various kinds of conditions such as a connection starting time, a call distance, a total time connected and so on, and converts the inputted dial number to a different dial number by adding an identification number corresponding to the communication line or the like. Further, the converted dial number is sent to the switching apparatus 10 through the network controller 22 so that the communication apparatus is connected to the selected line among a plurality of public communication lines 13, and a connection with the called party's communication apparatus is established.

With a proxy LCR function, the facsimile apparatus 31 is capable of taking over a calling operation for a branched non-LCR apparatus connected to the same line 21.

The telephone set 32 includes the network controller 22, the handset 211, dial keys 210 and the DTMF detecting circuit 214 as shown in FIG. 2.

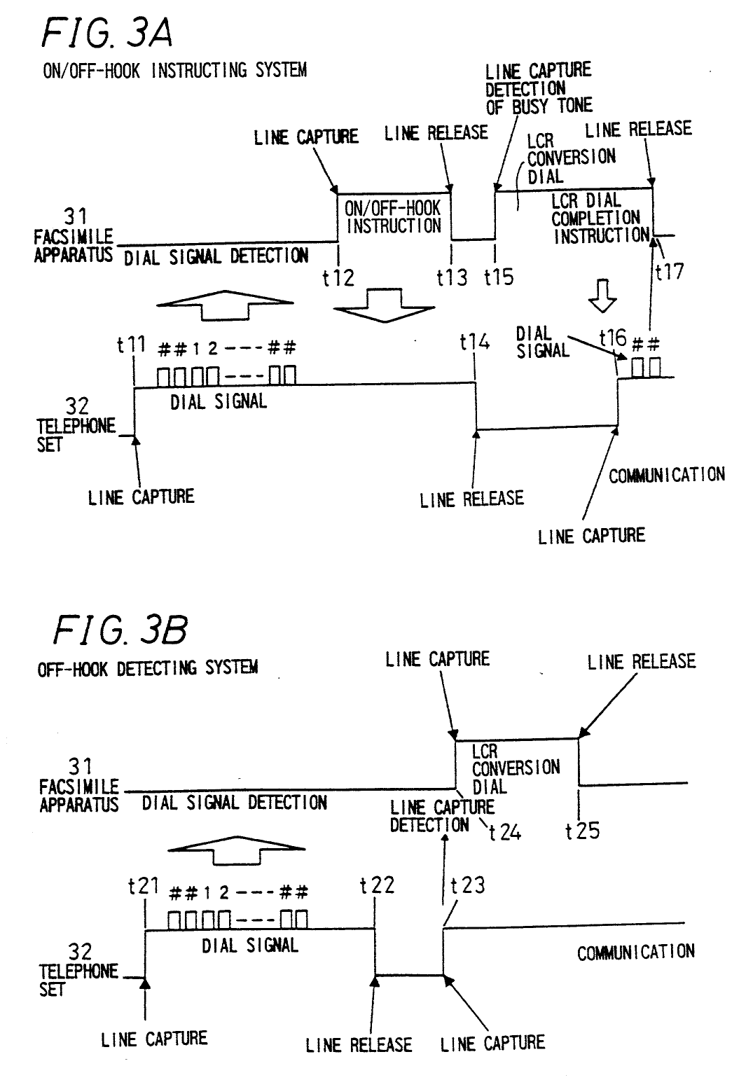

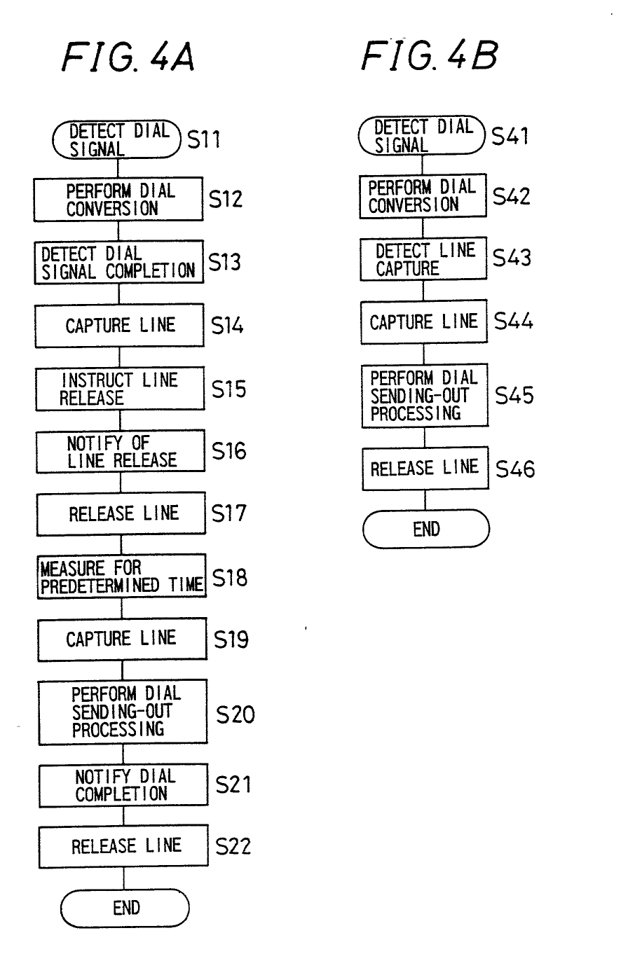

FIGS. 3A and 3B are timing charts for explaining the operation of a proxy LCR function. Here, an on-hook and off-hook instruction system as shown in FIG. 3A and an off-hook detection system as shown in FIG. 3B will be explained with reference to FIGS. 4A and 4B, which are operation flowcharts of the on-hook and off-hook instruction system provided to the facsimile apparatus 31.

First, with reference to FIGS. 3A and 4A, an on-hook and off-hook instruction system is explained. When a caller picks up a handset of a telephone set 32 at time t11, a line 21 is captured, and the switching apparatus 10 controlling the captured line 21 sends a dial tone to the telephone set 32 to let the caller know that a calling operation is possible. Then, when the caller inputs a called party's telephone number, the telephone set 32 transmits a dial signal to the line 21. Based on the transmitted dial signal, the switching apparatus 10 connects the telephone set 32 to a line that can be connected to the called party's communication apparatus to establish a communication line.

On the other hand, in cases where the caller wishes to use the LCR function, in dialing the called party's telephone number, for example, two sharps “##” are added as an identification code prefix to the called party's telephone number. In response to that, the switching apparatus 10 judges that the signal received is different from that of a normal phone number and sends a busy tone to the line 21 to notify the telephone set 32 that the call is rejected.

The facsimile apparatus 31 monitors signals transmitted over the line 21 with a DTMF detecting circuit 214 at all times. Upon detecting a dial signal including LCR-start command prefix “##” (step s11), the facsimile apparatus 31 starts an operation of the proxy LCR function.

Further, the call detection can be made possible in the state that the line is released, by employing a high input impedance detecting circuit for the DTMF detecting circuit 214, and thus errors in operations of the telephone set 32 or the switching apparatus 10 can be prevented.

The controller 24 performs a dial conversion processing to convert a dial signal transmitted from the telephone set 32 and detected by the DTMF detecting circuit 214 to a different dial signal (step s12). At this time, when a dial conversion using the LCR function is performed, the least expensive communication line is selected based on various conditions of the call such as a connection starting time, a call distance, a total time connected, referring to an LCR table stored in the RAMs 215, 216. The identification number corresponding to the selected communication line is read out and which number is added to the called party's phone number.

Notification of completion of calling operation on the telephone set 32 is done by adding an LCR code as a call-end command suffix, such as two sharps “##” for example, at the end of the called party's telephone number.

Further, upon detecting a command “##” suffix of the called number (step s13), the controller 24 captures the line 21 at time t12 (step s14) and performs a line releasing instruction processing (step s15). Then, the controller 24 sends an instruction to release the line to the telephone set 32 by a voice message, melody, tone signal or the like (step s16), and releases the line 21 at time t13 (step s17). In the case of a voice message, the controller 24 sends a synthesized voice message such as, “Please hang up and wait for a moment. Then, pick up the handset again”. In accordance with the message, the caller of the telephone set 32 puts back the handset to on-hook, the line 21 is released at time t14.

After releasing the line at time t13, the controller 24 waits until an predetermined length of time passes, which is an estimated time to take before the telephone set 32 is on-hooked (step s18). Then, the controller 24 again captures the line 21 at time t15 (step s19), and performs a dial signal sending operation for sending a converted dial signal (step s20). Such a point of time can be set as the timing of re-capturing the line that a predetermined time has passed based on timing of the capture of line by the telephone set 32 at time t11, the completion of dial signal transmission from the telephone set 32, the release of line at time 13, or the release of line by the telephone set 32 at time t14.

In addition, at time t15 when the line 21 is recaptured, a signal transmitted through the line 21 is monitored, and if a busy tone is detected, the line can be released again for a predetermined time. In this case, the switching apparatus will then be able to promptly perform the line release processing, and the controller 24 will again capture the line.

When the handset of the telephone set 32 is picked up while the converted dial signal is sent, the telephone set 32 again captures the line at time t16. When the whole converted dial signal is sent, the switching apparatus 10 establishes a connection with a called party's communication apparatus over an appropriate line selected in accordance with the dial signal just received, thereby making it possible the caller begin conversation on the telephone set 32.

Upon completion of sending the converted dial signal, the controller 24 transmits a call completion message to the telephone set 32 by a voice message, melody or tone signal for a predetermined period of time (step s21). The controller 24 then releases the line 21 at time t17 (step s22). In this case, if the caller wishes to interrupt the transmission of the call completion message, the caller inputs two sharps “##” for example, as a message-end command. When the controller 24 detects the message-end command, the controller 24 interrupts the transmission of the call completion message so that conversation on the telephone set 32 can be prevented from being interfered.

When the caller wishes to finish a calling operation on the telephone set 32 in the middle of calling, it can be notified to the facsimile apparatus 31 by calling a call-end command consisting of one or more of dial keys #, *, 0 to 9, by holding the line for a while without calling any keys, or by hanging up the handset. When detecting any of these situations or finding a short or excess of digits of the dial signal detected, the controller 24 aborts the operation of the proxy LCR function.

Next, an off-hook detection system will be explained with reference to FIGS. 3B and 4B. When the caller picks up the handset of the telephone set 32 at time t21, the line 21 is captured, and the switching apparatus 10 at the captured line 21 sends a dial tone to the telephone set 32, letting know that a calling operation is possible. Then, when the caller inputs a called party's telephone number, the telephone set 32 transmits a dial signal to the line 21.

On the other hand, in cases where the caller wishes to use the LCR function on the telephone set 32, which is a non-LCR apparatus, the caller begins calling with an LCR code, two sharps “##” for example, before the called party's telephone number. Upon receiving the LCR code, the switching apparatus 10 determines that the signal received is different from that of a normal phone number and sends a busy tone to the line 21 to notify the telephone set 32 that the call operation is rejected.

The facsimile apparatus 31 monitors signals transmitted over the line 21 with a DTMF detecting circuit 214 at all times. When the facsimile apparatus 31 detects a dial signal of the called party's phone number including LCR command prefix “##” (step s41), the facsimile apparatus 31 starts the operation of proxy LCR function.

Referring to an LCR table and the like, the controller 24 performs a dial conversion processing for converting the dial signal sent from the telephone set 32 and detected by the DTMF detecting circuit 214, to a different dial signal (step s42).

Completion of calling operation on the telephone set 32 is notified by adding an LCR code as a call-end command suffix, such as two sharps “##” for example, to the end of the called party's telephone number. Then, after the caller puts back the handset of the telephone set 32 at time t22 and the line 21 is released once, the caller again picks up the handset at time t23 to capture the line 21. Upon detecting the release of line at time t22, the switching apparatus 10 judges termination of communication. At the time of capturing the line 21 at time t23, the switching apparatus 10 sends a dial tone to the telephone set 32 to notify the telephone set 32 that a calling operation is possible.

When the controller 24 detects the capture of the line 21 by the telephone set 32 at time t23 (step s43), the controller 24 again captures the line 21 at time t24 (step s44) and performs dial signal sending operation. The controller 24 then sends a converted dial signal (step s45) and releases the line 21 at time t25 (step s46) . The switching apparatus 10 connects the communication apparatus to a line that can be connected to a called party's communication apparatus, based on the transmitted dial signal, to establish a communication line, thereby making the caller's communication with the called party using the telephone set 32 possible.

Thus, in the on-hook and off-hook instruction system as shown in FIG. 3A, an on-hook or an off-hook instruction can be given by the facsimile apparatus 31 to the telephone set 32. In the case of the off-hook detection system as shown in FIG. 3B, no instruction from the facsimile apparatus 31 to the telephone set 32 is necessary, because the caller can listen to the converted dial signal while the facsimile apparatus 31 sends the converted call.

As explained above, the given explanation is a case where a facsimile apparatus 31 provided with the proxy LCR function is connected with non-LCR telephone sets 32. However, in cases where a plurality of facsimile apparatuses are connected in parallel or where only telephone sets are connected in parallel, as well, it is sufficient to have only one LCR apparatus provided with the proxy LCR function in order to obtain the same effects.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication apparatus for communicating over a line connected to a public communication line via a switching apparatus, comprising:
call detecting means for detecting a dial signal sent by another communication apparatus connected to the line in parallel;
dial converting means for converting the dial signal detected by the call detecting means to another dial signal; and
call sending-out means for sending the other dial signal converted by the dial converting means to the switching apparatus, and establishing a communication line.

2. The communication apparatus of claim 1, wherein the dial converting means has a line selection table for use in selecting a desired public communication line from among a plurality of public communication lines.

3. The communication apparatus of claim 2, wherein the line selection table is an least cost routing table.

4. The communication apparatus of claim 1, wherein the call detecting means activates the dial converting means when the call detecting means detects a predetermined signal in the dial signal sent by the other communication apparatus.

5. The communication apparatus of claim 1, wherein the dial detecting means detects the dial signal by a high input impedance, and
the dial sending-out means captures the line when a predetermined time has elapsed since release of the line and sends the converted dial signal.

6. The communication apparatus of claim 1, comprising:
line release instruction means for, when the dial detecting means detects the dial signal sent from the other communication apparatus, instructing the other apparatus to release the line.

7. The communication apparatus of claim 1, wherein, when the other communication apparatus releases the line after the sending-out of the dial signal and again captures the line, the dial sending-out means sends the converted dial signal.

8. The communication apparatus of claim 4, wherein the predetermined signal is composed of one or more of dial keys #, *, 0 to 9.

9. The communication apparatus of claim 8, wherein, when the dial detecting means detects the predetermined signal in the dial signal sent out by the other communication apparatus, the dial detecting means judges that sending-out of the dial signal is completed.

10. The communication apparatus of claim 8, wherein, when the predetermined signal is detected in the dial signal sent-out by the other communication apparatus, when the sending-out of the dial signal is interrupted for a predetermined time, when a digit number of the detected dial signal is insufficient or excessive, or when the line is released during the sending-out of the dial signal, the dial detecting means does not activate the dial converting means.

11. The communication apparatus of claim 1, wherein, when the dial sending-out means detects, in capturing the line and sending out the converted dial signal, a busy tone from the switching apparatus, the dial sending-out means releases the line for a predetermined time and thereafter captures the line to send the converted dial signal.

12. The communication apparatus of claim 1, comprising:
call completion notifying means for notifying the other communication apparatus of call completion when the dial converting means completely sends the converted dial signal.

13. The communication apparatus of claim 12, wherein when the other communication apparatus sends a predetermined signal during the notification of the call completion by the call completion notifying means, the call completion notifying means terminates the notification of the call completion.
